(19) United States
(12) Patent Application Publication
(10) Pub. No.: US 2026/0030869 A1
(43) Pub. Date: Jan. 29, 2026

(54) SYSTEMS AND METHODS FOR IMAGE OBJECT IDENTIFICATION BASED ON SIMILARITY ANALYSIS

(71) Applicant: rewardStyle, Inc., Dallas, TX (US)

(72) Inventors: Baxter BOX, Dallas, TX (US); Ty AMELL, San Francisco, CA (US); Oliver Dsouza, Sammamish, WA (US); Morgan Cundiff, Mill Creek, WA (US); Nate Jones, Chicago, IL (US)

(21) Appl. No.: 19/259,424

(22) Filed: Jul. 3, 2025

Related U.S. Application Data
(60) Provisional application No. 63/675,907, filed on Jul. 26, 2024.

(51) Int. Cl. G06V 10/764; G06Q 30/0601; G06V 10/26

(52) U.S. Cl. CPC G06V 10/764; G06Q 30/0625; G06V 10/273

(57) ABSTRACT

A computer-implemented method for product identification and classification in an image includes receiving, with one or more processors, an image containing a being a product and inputting the received image to at least one model. The at least one model may be configured to: identify a location of the product within the image, output the location of the product within the image as a crop image, generate a product classification for the product in the crop image, and generate a product embedding according to the product classification. The method may further include outputting the product embedding to a search service configured to return product data associated with at least one similar product, receiving, with the one or more processors, the product data returned by the search service, and generating, with the one or more processors, one or more image tags based on the at least one similar product.

### CROSS-REFERENCE TO RELATED APPLICATIONS

This application claims the benefit of priority from U.S. Provisional Application No. 63/675,907, filed on Jul. 26, 2024, which is incorporated by reference herein in its entirety.

### TECHNICAL FIELD

Various embodiments of the present disclosure relate generally to image analysis, and in particular, to modeling methods for identifying objects in an image.

### BACKGROUND

Image analytical techniques are useful in various applications, including in image-based searching, medical diagnostics, and even autonomous vehicle control. Analytical techniques for processing still or moving images have significantly improved in recent years. For example, advances in machine vision allow computing systems to identify the outlines of objects, and in some situations, estimate the identities of the objects themselves. The ability to automatically detect objects in images has improved image searching, comparative analytics applied to images, image editing or correction, and others.

While helpful, conventional image analytical techniques require significant computational resources, involve large data sets, and are cumbersome to implement. Additionally, existing techniques for identifying the type of object(s) present in an image are inaccurate in at least some circumstances. For example, when an obstruction is present in front of an object of interest, the object of interest can be difficult to identify, incorrectly identified, or unable to be identified. Some strategies require the generation of large, tailored data sets that are application-specific. These challenges are further exacerbated when dealing with moving images (e.g., a video), which contain a large number of frames to be processed or analyzed for object detection.

Analytical systems configured to process images are typically configured to perform tasks such as searching, subject identification, etc. These analytical systems are not typically capable of rapidly or immediately providing output data for use as part of a process performed with downstream systems—the search or subject identification is the sole or primary output. Further, integration of analytical systems with downstream systems, such as communication services, media creation services, and others, is slow and computationally intensive. Image searching systems, for example, often rely on user inputs, search queries, item selections, and other manual activities that increase processing time, negatively impact user experience, and potentially introduce errors.

Some applications involve the storage of large amounts of data, for, as an example, product catalogs. A product catalog may be stored as a large collection of products, each product having multiple entries within a database. For example, each single item in the product catalog may have child elements, these elements having further variations in color and size. As a result, the data storage for the product catalog can be structured as a multi-level tree of nodes, the nodes formed as individual items associated with siblings, children, parents, etc.

Due to their size, data collections typically benefit from categorization and organization. In the example of databases storing data for articles of clothing, categorization can be performed based on categories such as Men, Women, Jewelry, and Shoes, as a few examples. Items in product catalogs are often updated as new items are added, updated, and deleted. As the size of the collection increases, the product catalog can become challenging to navigate or even unmanageable. This results in lengthy delays to locate items and other negative impacts. While manual searching by use of an indexer, title, and product descriptions to identify desired elements, filters, etc., are helpful, these approaches rely upon user-entered search queries. These queries can be difficult to generate or omit relevant results as a result of the large collection of items in the catalog, user error, etc.

The present disclosure is directed to overcoming one or more of these above-referenced challenges.

### SUMMARY OF THE DISCLOSURE

According to certain aspects of the present disclosure, systems and methods are disclosed for identifying objects in an image.

In one embodiment, a computer-implemented method for product identification and classification in an image may include receiving, with one or more processors, an image containing a plurality of objects, the image having been captured with an image sensor, at least one of the plurality of objects in the image being a product and inputting, with the one or more processors, the received image to at least one model. The at least one model may be configured to: identify a location of the product within the image, output the location of the product within the image as a crop image, generate a product classification for the product in the crop image, and generate a product embedding according to the product classification. The method may further include outputting, with the one or more processors, the product embedding to a search service configured to return product data associated with at least one similar product, receiving, with the one or more processors, the product data returned by the search service, and generating, with the one or more processors, one or more image tags based on the at least one similar product.

In another embodiment, a system for product identification and classification in an image may include a data storage device storing instructions and a processor configured to execute the instructions to perform a method, the method including receiving, with one or more processors, an image containing a plurality of objects, the image having been captured with an image sensor, at least one of the plurality of objects in the image being a product and inputting, with the one or more processors, the received image to at least one model. The at least one model may be configured to: identify a location of the product within the image, output the location of the product within the image as a crop image, generate a product classification for the product in the crop image, and generate a product embedding according to the product classification. The method may further include outputting, with the one or more processors, the product embedding to a search service configured to return product data associated with at least one similar product, receiving, with the one or more processors, the product data returned by the search service, and generating, with the one or more processors, one or more image tags based on the at least one similar product.

In yet another embodiment, a non-transitory machine-readable medium may store instructions that, when executed by a computing system, cause the computing system to perform a method including receiving, with one or more processors, an image containing a plurality of objects, the image having been captured with an image sensor, at least one of the plurality of objects in the image being a product and inputting, with the one or more processors, the received image to at least one model. The at least one model may be configured to: identify a location of the product within the image, output the location of the product within the image as a crop image, generate a product classification for the product in the crop image, and generate a product embedding according to the product classification. The method may further include outputting, with the one or more processors, the product embedding to a search service configured to return product data associated with at least one similar product, receiving, with the one or more processors, the product data returned by the search service, and generating, with the one or more processors, one or more image tags based on the at least one similar product.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system for identifying objects in an image, according to one or more embodiments.

FIG. 2 depicts a block diagram showing components of a system for identifying objects in an image, according to one or more embodiments.

FIG. 3 depicts a flowchart of a method of identifying objects in an image, according to one or more embodiments.

FIG. 4 depicts an image including a plurality of image crops, according to one or more embodiments.

FIG. 5 depicts an output for identifying objects in an image, according to one or more embodiments.

FIG. 6 depicts a plurality of results returned in response to a search performed for an embedding, according to one or more embodiments.

FIG. 7 depicts an example image and an example image crop, according to one or more embodiments.

FIGS. 8A-8C depicts example graphical user interfaces presenting similarity results, according to one or more embodiments.

FIGS. 9A and 9B depicts example graphical user interfaces presenting elements for interacting with outputs of the system for identifying and auto-tagging objects, according to one or more embodiments.

FIGS. 10A and 10B depicts example graphical user interfaces for requesting presentation of an output of the system for identifying and auto-tagging objects in an image, according to one or more embodiments.

FIGS. 11A and 11B depicts example graphical user interfaces for requesting presentation of an output of the system for identifying and auto-tagging objects in a video, according to one or more embodiments.

FIG. 12 depicts an implementation of a computer system that executes techniques presented herein.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to an image analysis system for identifying products in an image, classifying the product, and identifying one or more similar product images. In one or more embodiments, the image analysis system receives image data and generates embeddings based on the image data. In some embodiments, video data comprising a plurality of image frames may be received. In some examples, video data may include the same products throughout an entirety of the image frames, and thus one image frame (e.g., a cover image frame) may be representative of and include all products in the video data. Thus, providing the cover image frame as image data for embedding generation may be sufficient. However, in other examples, different image frames of the video data may include different products such that the cover image frame would only be representative of a portion of the products in the video. But, generating embeddings for each of the image frames is resource intensive, and typically a scene change (e.g., a content change) between a substantial portion of the image frames is minimal for purposes of embedding generation. For example, there may be no new or different objects between many of the image frames, and thus the same or highly similar embeddings would be generated for each of the image frames (e.g., unnecessarily wasting resources). Therefore, to conserve resources while otherwise enabling all products within the video data to be identified, subsequent image frames at predefined frame intervals (e.g., first and second image frames, second and third image frames, etc.) may be initially processed to determine if there is a scene or content change above a threshold (e.g., a threshold indicative of a new or different object included in the latter image frame). If so, the latter image frame may be provided as image data to generate an embedding based thereon. Otherwise, the latter image frame may be discarded from the embedding generation process.

These generated embeddings are useful, for example, for training and/or retraining a machine learning model, determining the classification for the image, and for identifying similar images with associated product data. As described herein, an embedding is an object useful for representing at least a portion of an image in a format suitable for data science techniques (e.g., modelling, machine learning, neural networks, etc.). An embedding may be a signature or identifier that uniquely identifies an image or portion of an image for a search query. If desired, the similar images are used by the system to make product recommendations and/or dynamically redirect retailer product links in online content. The system may provide automations useful, for example, in content creation.

At least some embodiments utilize creation and analyses of embeddings. Each embedding may correspond to a product and provide data suitable for analytical techniques to determine the similarity of a plurality of embeddings. A two-phase analysis may enable identification of a location of an object of interest and classification of the object in a first phase. A second phase may generate an embedding and identify one or more similar embeddings. Use of a two-phase process may improve accuracy, reduce processing time, and provide other benefits in comparison to conventional approaches to image analysis. For example, the first phase will improve the overall performance of the image analysis and similarity search system by utilizing a model to filter out products that are irrelevant for search purposes (e.g., products that are associated or not associated with certain classifications), thus improving the results of the second phase by leading to the largest gains in identifying similar embeddings. The second phase utilizes a fine-tuned model for identifying crop images resembling products in a database. The initial version of the model may be utilized without extensive manual data labeling, leading to a significant saving of computational resources, as it is pre-trained on a vast amount of data from multiple data sources, providing substantial context across various categories/classifications and eliminating the need for specialized classifications for different attributes such as, for example, trends, colors, and the like. The model in the second phase may also be further enhanced via re-training, for example by incorporating training data and examples from specific data sets to fine-tune the model for specific use cases.

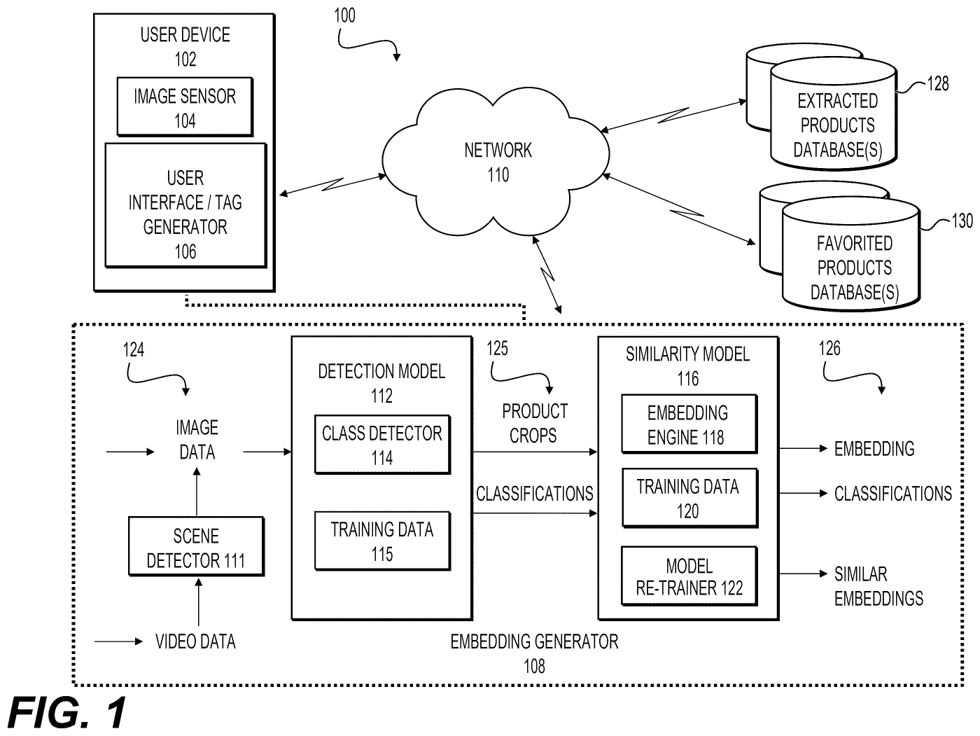

FIG. 1 is an exemplary block diagram of a system environment 100 for identifying and auto-tagging objects, according to one or more embodiments. As shown in FIG. 1, system environment 100 may include a user device 102, an embedding generator 108, one or more extracted products databases 128, and one or more favorited products databases 130. User device 102 or embedding generator 108 may form an example of a system for identifying and auto-tagging objects. In some configurations, user device 102 and embedding generator 108 together form an implementation of a system for identifying and auto-tagging objects.

As used herein, the phrase “auto-tagging” includes generating an output useful to identify one or multiple products in an image, including a shoppable link. For example, an “auto-tagging” operation may include one or more of the following actions: identifying an object's location in an image, identifying a product in the image based on the product's classification, based on similar products, and/or based on other images of an identical product, or generating a shoppable link (e.g., a link included in product data, a link that is configured to lead a user to a page such as, for example, a webpage or a page within an application, where the product can be viewed and/or purchased) based on the identified product. In some aspects, an “auto-tagging” operation includes all of these actions.

A “shoppable link” may include URLs or other address formats that point, or link, to a website's specific page or subpage (a “deep link”), to a website's homepage, to an application (an “app”), to a page or a section within an application, etc., through which a visitor's analytics are tracked. For example, it is possible to create an “affiliate link” to an affiliate's home or main webpage, or to an affiliate's product webpage, with any activity, including product purchases being tracked and logged. In some examples, a shoppable link includes two operational components: (i) a component that directs the user to a website, a webpage, an app, or a page or a section within an app where a product is made available for purchase, and (ii) a component containing a tracking code (e.g., an identifier contained within a URL that identifies a particular content creator). A shoppable link may include variables and placeholders utilized by redirect scripts. This string of variables may include a content creator ID followed by additional redirect variables and the advertiser webpage URL.

User device 102, embedding generator 108, and databases 128 and 130, may be connected via a network 110 using one or more standard communication protocols. For example, content creators or other users may interact with user device 102 to create and upload content to one or more content sharing platforms. For example, content creators include social media influencers or bloggers.

User device 102 may be a mobile device such as a laptop computer, cellular phone, table, or other internet-connected device. In other examples, user device 102 is a desktop computer, server, etc. User device 102 includes components for receiving or generating raw image data, such as an image sensor 104 (e.g., a camera). While image sensor 104 is illustrated as being a component of user device 102, image sensor 104 may include hardware and/or software (e.g., memory, communication hardware, etc.) that receive images from an external image sensor. Examples of suitable sources for images include cellular phones, standalone cameras (e.g., DSLR cameras, point and shoot cameras, etc.), networked devices (e.g., via communications with the networking circuitry described below), non-networked devices, USB devices, permanent or removable memory drives (SD cards, hard drives, flash drives, M.2 drives, etc.) and others. Raw image data may include images that have not yet been analyzed for creation of an embedding.

User device 102 may also include a user interface or tag generator 106, including a display device and circuitry for controlling the display device to display a graphical user interface, as described below. User device 102 also includes input devices (e.g., a touchscreen, keyboard, mouse, etc.), and networking circuitry (e.g., cellular antennas, networking ports, Bluetooth radio, WiFi components, etc.) that allow user device 102 to communicate with other devices via network 110.

Embedding generator 108 may be implemented as a backend system (e.g., a server), a mobile device, or any other suitable computing system, including the systems described above with respect to user device 102. If desired, embedding generator 108 is included as a component of user device 102, such that a part or an entirety of embedding generator 108 is implemented in user device 102.

Embedding generator 108 may include at least one model, such as a machine learning model. Two example models are shown in FIG. 1, a detection model 112 and a similarity model 116 that are implemented with embedding generator 108. Additionally, the embedding generator may include a scene detector 111 that may be implemented with embedding generator 108. Embedding generator 108 may be configured to receive inputs 124 and generate outputs 126.

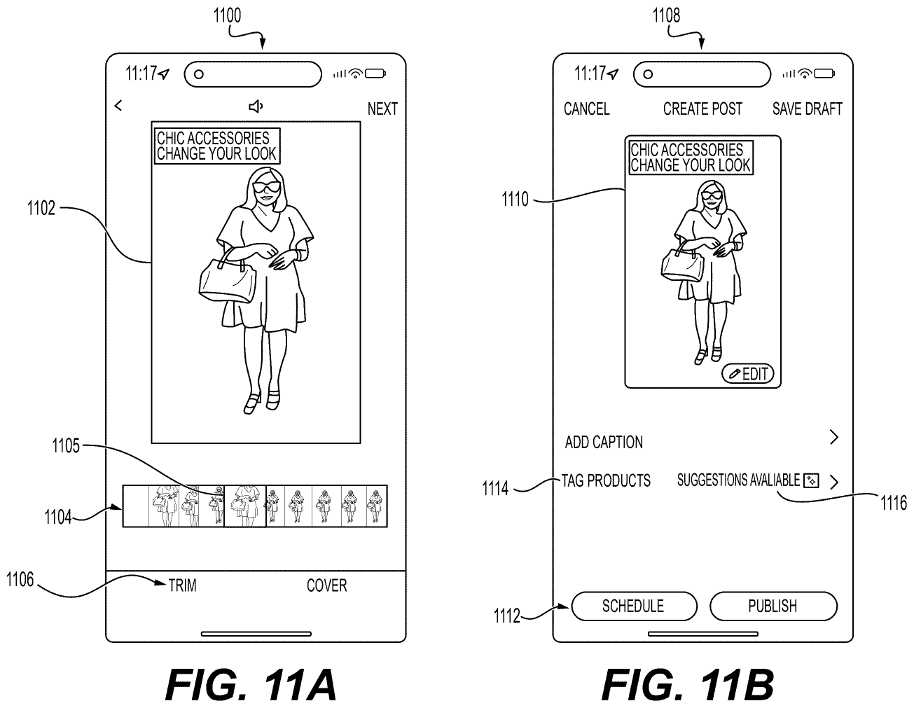

Inputs 124 received by embedding generator 108 may include image data, such as an image (e.g., a single image frame) generated with image sensor 104. The image data may be provided as input to detection model 112. In other examples, inputs 124 received by embedding generator 108 may include video data, such as a video comprising a series of images (e.g., a series of image frames) generated with image sensor 104. When video data is received, one image frame from the series of image frames may be selected as a cover image. Cover image selection may be based on an application of one or more algorithms to the series of image frames to select an optimal image (e.g., a default cover image). Additionally, or alternatively, the cover image may be manually selected from among the series of image frames by a content creator, as described below with reference to FIGS. 11A and 11B. In one example embodiment, the cover image for the video may be provided as image data to detection model 112.

In another example embodiment, when video data is received, the video data may be processed by a scene detector 111, and multiple image frames from the series of image frames may be provided as image data to detection model 112 to help ensure all products included in the video (e.g., products that may not be included in every image frame, such as the cover image) may be identifiable. For example, scene detector 111 may be configured to determine a change in scene (e.g., a change in content) between image frames, of the series of image frames, at a predetermined frame interval. When the change in scene exceeds a threshold, indicative of a new or different object in a subsequent image frame from a previous image frame, the subsequent image frame is also provided as image data to detection model 112. To provide an illustrative example, the video may be a wardrobe haul video during which multiple different clothing and/or accessory items may be tried on or interchanged by the content creator. Therefore, a first image frame may include a first outfit including a dress, purse, and shoes, whereas a two hundredth image frame may include a second outfit including a blouse and pants with the same purse and shoes. Scene detector 111 may be configured to detect the change in scene (e.g., the change in content) between the first image frame and the two hundredth image frame. As a result, each of the first image frame and the two hundredth image frame may be provided as image data to detection model 112. To provide another illustrative example, a manner in which the video is captured may cause certain products, such as shoes or a hat, to not be captured in every image frame or otherwise be obscured in certain image frames.

Example video data processing performed by scene detector 111 may include comparing of image frames (e.g. a first image frame and a second image frame) at a predetermined frame interval. For example, the first image frame may be an initial image frame in the series of image frames, and the second image frame may be a subsequent image frame in the series of image frames occurring at a predetermined period of time after the initial image frame (e.g., at the predetermined frame interval). The predetermined frame interval may be adjustable based on a total duration of the video (e.g., based on a number of image frames comprising the video). To provide a non-limiting, illustrative example, the predetermined frame interval may be every one hundred and fifty frames, and thus image frame 0 may be the first (e.g., initial) image frame, while image frame 150 may be the second (e.g., subsequent) image frame. In one example embodiment, the comparing may include determining, for each of the first and second image frames, a pixel intensity profile of the respective image frame. The pixel intensity profile may be representative of the scene or content within the respective image frame. The pixel intensity profiles for the first and second image frames may then be compared. The comparison may be a pixel-wise intensity comparison. Additionally, or alternatively, the comparison may implement histogram-based approaches.

Based on the comparison, a difference between the first and second image frames is determined. For example, a delta between the pixel intensity profiles of the first and second image frames may be determined. The difference determined may be compared to a threshold difference. The threshold difference may be a difference indicative of a new or different object included in the scene or content of the second image frame. If the difference determined between the first and second image frames meets or exceeds the threshold difference, the second image frame may be provided as image data to detection model 112 (e.g., in addition to the first image frame), and the process may repeat by comparing the second image frame to a third image frame (e.g., a next subsequent image frame) at the predetermined frame interval, and so on. If the difference determined between the first and second image frames is less than the threshold difference, then the second image frame is discarded, and the process may repeat by comparing the second image frame to the third image frame at the predetermined frame interval, and so on.

Detection model 112 may be configured to receive the image data. Detection model 112 may include a class detector 114 that enables detection model 112 to generate product crops, classifications, and other of object detection results 125. For instance, the outputs of detection model 112 may include product crops, classifications, and other object detection results, collectively labeled as 125 in FIG. 1. Product crops may correspond to portions of an image received as inputs 124, each portion including a product. The location (relative to the entire raw image data), size, and shape of the image crop may be determined according to the product contained within the boundaries of the product crop. The classification, a part of object detection results 125 that are output from detection model 112, may represent the type of product present in the product crop. In the example of wearable products (e.g., clothing and accessories), example classifications may include:

| Class | Example Class Members |
|---|---|
| Top | Coats & Jackets, Cardigans, Hoodies & |
| | sweatshirts, Tops, Sweaters, Sleepwear |
| Bottom | Jeans, Leggings, Activewear Pants, Shorts, |
| | Skirts, Other Pants, Sleepwear |
| Dress | Dresses |
| Shoe | Boots, Heels, Closed-Toe Flats, Sandals & |
| | Wedges, Sneakers and Athletic, Other Shoes |
| Bag | Bags, Other Accessories |
| Other | Intimate Wear, Jumpers and Rompers, Other |
| | Accessories, Belts, Hair Accessories, Hats, |
| | Bracelets, Earrings, Necklaces, Rings, |
| | Watches, Suits, Other Clothing, Eyewear, |
| | Swimwear |

Detection model 112 may be a machine learning model that was trained based on training data 115. Detection model 112 may be configured to identify product crops, as described below. In some examples, detection model 112 is configured as a computer vision model. In some examples, detection model 112 is configured to identify and output classifications (e.g., class labels) in real-time or near real-time. Detection model 112 may be configured as a YOLOv8 model, for example.

In some aspects, detection model 112 may be configured to identify a product that is partially obscured by another object. For example, if a crop image contains a bag overlaying and partially obscuring a product (e.g., a pair of pants), detection model 112 may be configured to prioritize products of interest (e.g., pants) over other objects. Prioritization may be determined according to object classification determined with detection model 112, as described below. Class labels obtained via model 112 may enable system(s) of system environment 100 to match crop images with favorited products having the same or a similar classification. Use of classification may improve performance of model 112 by filtering out objects or products that are not relevant (e.g., objects or products that are associated with certain classifications or class labels that are pre-determined to be excluded from further processing such as, for example, similarity search).

Similarity model 116 may include an embedding engine 118 configured to generate embeddings, training data 120 on which similarity model 116 was trained, and a model re-trainer 122 configured to update training data 120 and re-train similarity model 116. The embeddings of outputs 126 may correspond to embeddings generated in response to the image data.

Similarity model 116 may be a machine-learning based model. Similarity model 116 may be implemented via a neural network that was trained on images and text included in training data 120. Similarity model 116 may include components configured for text and image analysis. For example, model 116 includes a text encoder and an image encoder. An example of a suitable model is a Contrastive Language-Image Pre-training (CLIP) model that has been trained with large sets of training data 115.

Similarity model 116 may map text and images into embeddings. In the example where clothing is a product of interest, similarity model 116 may be trained for images including blue dresses, the embeddings of each image containing a blue dress being mapped with a unique identifier. The mappings may be transformed to a graph, enabling similarity model 116 to identify all images that, based on the graph, are similar. Similarity model 116 may identify a cluster of points a predetermined distance, or less, from the embedding used to generate a query. Similarity model 116 may return product images and product data for each embedding identifier in the cluster (e.g., a blue dress). An exemplary model that may be implemented as a part or an entirety of similarity model 116 is a CLIP model. A CLIP model may have been trained on publicly-available databases, providing similarity model 116 with significant context for a plurality of categories. Use of a model such as a CLIP model may reduce or eliminate the need for specialized classifications for different trends, colors, or other specific product characteristics.

One or both of models 112 and 116 may be a machine learning model. As used herein, a machine learning model is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as transfer learning, linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

The machine learning model may be a trained neural network model. The machine learning model may be trained on a datasets described with respect to databases 128 and/or 130. The methods described herein may be implemented by embedding generator 108 to create a model dataset used for the training of the machine learning model(s) (e.g., via training data 115 or training data 120) to predict product crops, classifications, embeddings, etc., taking into account a priori information associated with past predictions.

A neural network may be software representing the human neural system (e.g., cognitive system). A neural network may include a series of layers termed “neurons” or “nodes.” A neural network may comprise an input layer, to which data is presented, one or more internal layers, and an output layer. The number of neurons in each layer may be related to the complexity of a problem to be solved. Input neurons may receive data being presented and then transmit the data to the first internal layer through connections' weight. Any suitable type of neural network may be used.

Database 128 may store one or more datasets for objects of interest, also referred to herein as “products.” As used herein, a “product” is not limited to articles available for purchase, but may include any object capable of being represented in a photograph or other image. Further, the term “image” includes static images or dynamic images (e.g., images in which part or an entirety of the image moves, videos, etc.). The information associated with products in database 128 may be obtained by extracting or scraping product data from a plurality of websites and/or associated databases. Additionally or alternatively, database 128 may include a portion or an entirety of a product catalog generated by loading or transforming entries of an existing product catalog. In some embodiments, a taxonomy associated with products in database 128 may be stored in database 128. In some embodiments, a product catalog is generated to include products sold by multiple retailers, the product catalog being in database 128. In these or other embodiments, a product catalog may be generated based on the product-related data gathered and stored in database 128 (e.g., via scraping accessible sources, such as websites, webpages, etc.).

Datasets stored in one or more extracted product databases 128 may include embeddings associated with a plurality of products. At least some products may be associated with a plurality of embeddings in one or more extracted product databases 128. In addition to these embeddings, also referred to herein as product embeddings, datasets stored in extracted product databases 128 may include product data. As described below, product data may be associated with a particular product, and may represent one or more of: a classification of the product, an image of the product, a source (e.g., manufacturer, brand) of the product, a unique identifier for the product, an identifier (e.g., a “favorite ID”) identifying the product as a favorited product of a particular user (e.g., a particular content creator), a user identifier, a location (e.g., URL) of an image of the product, or descriptive text.

The embeddings and product data stored in one or more extracted product databases 128 may have been generated in an automated manner. For example, publicly-available databases may communicate with one or more extracted product databases 128, via network 110, allowing one or more extracted product databases 128 to extract and generate product data and further generate embeddings based on this generated product data.

One or more favorited products databases 130 may, like one or more extracted product databases 128, store product embeddings. In some examples, one or more favorited products databases 130 may store product embeddings that were generated in response to a user-initiated event, such as favoriting a product, as described below. If desired, at least some product data stored in one or more favorited products databases 130 may be retrieved from one or more public databases, as described above. Similar to database 128, the product-related data stored in database 130 may be in an organized format, such as by utilizing a system of classification (e.g., taxonomy). In some embodiments, a taxonomy associated with products in database 130 may be stored in database 130. While databases 128 and 130 are illustrated as being separate databases that are both in communication with network 110, as understood, extracted product database 128 and favorited products database 130 may be implemented by a single database or distributed across one or more accessible databases. Further, databases 128 and 130 may be incorporated as part of embedding generator 108 and/or user device 102.

Model re-trainer 122 may be configured to update training data 120 and retrain similarity model 116 periodically, or continuously. If desired, detection model 112 may include a model re-trainer that operates in a manner that is similar to re-trainer 122. Model re-trainer 122 may perform re-training based on updated product data. Updated product data may be provided to, or from, databases 128 and 130. Updated product data may be generated based on favoritings, the creation of new products, changes in existing products, etc.

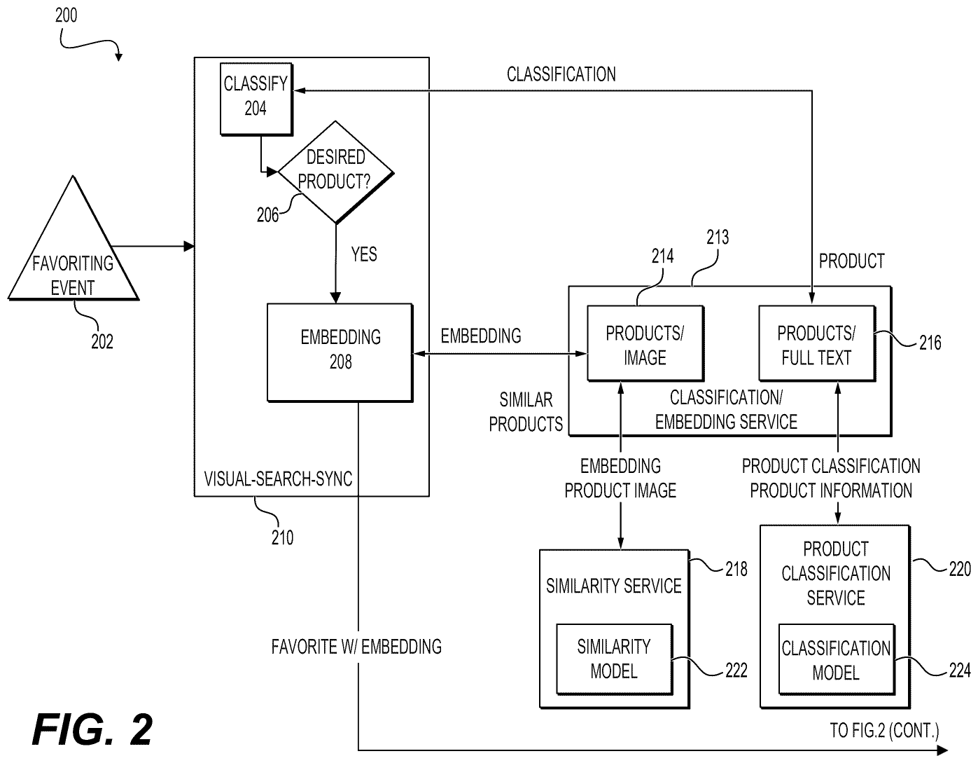

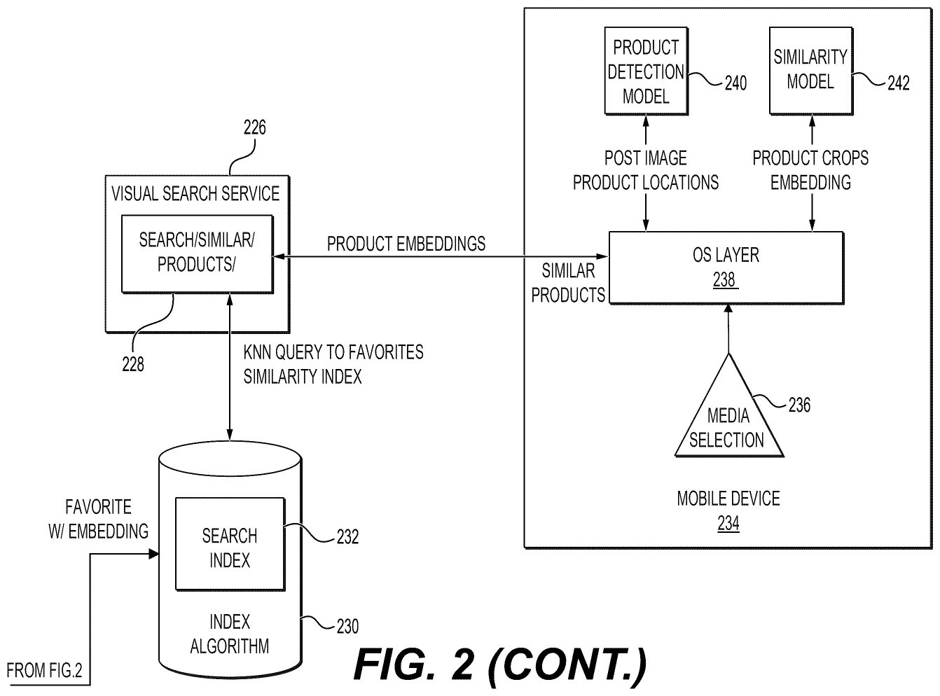

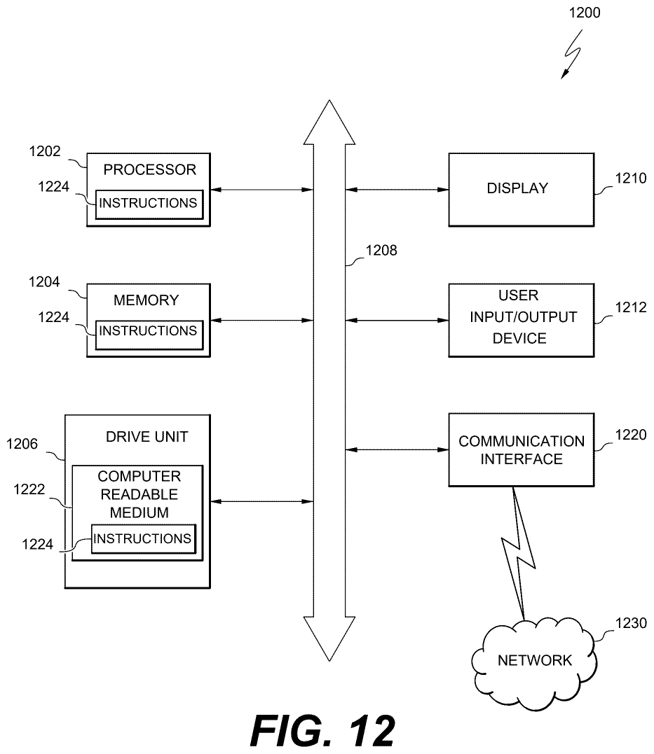

FIG. 2 is a block diagram illustrating actions, communications, and algorithms that facilitate identifying objects in an image. These functions and structures may facilitate a system 200 for identifying and auto-tagging objects, according to one or more embodiments. In system 200, a visual-search-sync service 210, classification/embedding service 213, similarity service 218, product classification service 220, visual search service 226, may correspond to embedding generator 108 and/or user device 102 (FIG. 1). Mobile device 234 may correspond to user device 102 and, in some embodiments, is a device other than a mobile device (e.g., such as those described in reference to FIG. 12).

An event 202, e.g., a favoriting event as shown in FIG. 2, may be initiated by a user. In particular, a user (e.g., a content creator) may designate one or more products and associated images being shown in an application he/she is using (e.g., a content creation application, a web browsing application, a social media application, etc.) as a “favorite” (see the discussion of graphical 820 below). System 200 may be configured to perform a process for generating an embedding in response to each favoriting event 202.

A visual-search-sync service 210 may receive a product as an input. In some examples, the product received as an input to visual-search-sync service 210 is product data for the product favorited via event 202. Visual-search-sync service 210 may also be configured to send a product (or associated product) as an input to classification/embedding service 213. In response, visual-search-sync service 210 may receive a classification 204 for the product from classification/embedding service 213. When it is determined that the product is a desired product 206, visual-search-sync service 210 may generate or receive from classification/embedding service 213 the embedding 208 for the favorited product, this favoriting designation and product embedding being output to a search service such as search service implementing index algorithm 230, as described below.

Classification/embedding service 213 may output the classification and product embedding for visual-search-sync service 210. Classification/embedding service 213 may include a products/full text store 216 and a products/image store 214. Full text store 216 may include product information that is provided by classification/embedding service 213 to a product classification service 220 that includes classification model 224. Image store 214 may include product images that are provided by classification/embedding service 213 to a similarity service 218 that includes similarity model 222.

Similarity model 222 may correspond to similarity model 116 and may function as described above to generate product embeddings that are output to classification/embedding service 213 and visual-search-sync service 210. Classification model 224 may correspond to detection model 112 and may function as described above to generate product classifications that are output to classification/embedding service 213 and visual-search-sync service 210 in a first phase of an image identification process.

As described above, index algorithm 230 may receive favoriting designations and product embeddings from visual-search-sync service 210. Index algorithm 230 may be configured to process and store each received favoriting and update a search index 232. Search index 232 may include embeddings and product data for one or a plurality of favorited products in a predetermined or standardized format or data structure. The formatting or structure of the data in search index 232 may be suitable, based on the product embeddings, to identify similar embedding (e.g., embeddings for similar products). As used herein, a “similar product” may refer to a product that is different from the product used for generating a search. However, a “similar product” also encompasses a search result for the same product.

Visual search service 226 may be configured to query search index 232 of index algorithm 230 to identify products that are similar to a product embedding received as a query from a mobile device 234, as illustrated in FIG. 2, or product embeddings from other system. Visual search service 226 may query index algorithm 230 with a suitable search technique. In an example configuration represented in FIG. 2, visual search service 226 generates a command 228 for searching for similar products via a k-nearest neighbors (KNN) algorithm. Results of this search may be output to mobile device 234.

Mobile device 234 may be configured to generate one or more media selections 236. A media selection 236 may correspond to a content creator's selection of an image (e.g., a still image, video, etc.), or creation of a new image. Mobile device 234 may process this media via an operating system (OS) layer 238, upon which one or more applications (“Apps”) may operate, including functions for automatic tag generation (e.g., tag generator 106). These apps may receive selections for media, enable public posting of this media, communicate via one or more APIs with components of system 200, and present one or more similar products to an end user. In particular, one or more Apps operating via layer 238 may communicate with and/or include a product detection model 240 and similarity model 242.

Models 240 and 242 may correspond to detection model 112 and similarity model 116, respectively. Product detection model 240 may receive an image for posting (“post image”) and output one or more product locations, classifications of these products, etc. These outputs from model 240 may correspond to the above-described object detection results 125. Similarity model 242 may receive these product locations, or product crops, and generate product embeddings as outputs. The product embeddings generated with similarity model 242 may be used to generate a search with visual search service 226, as described above.

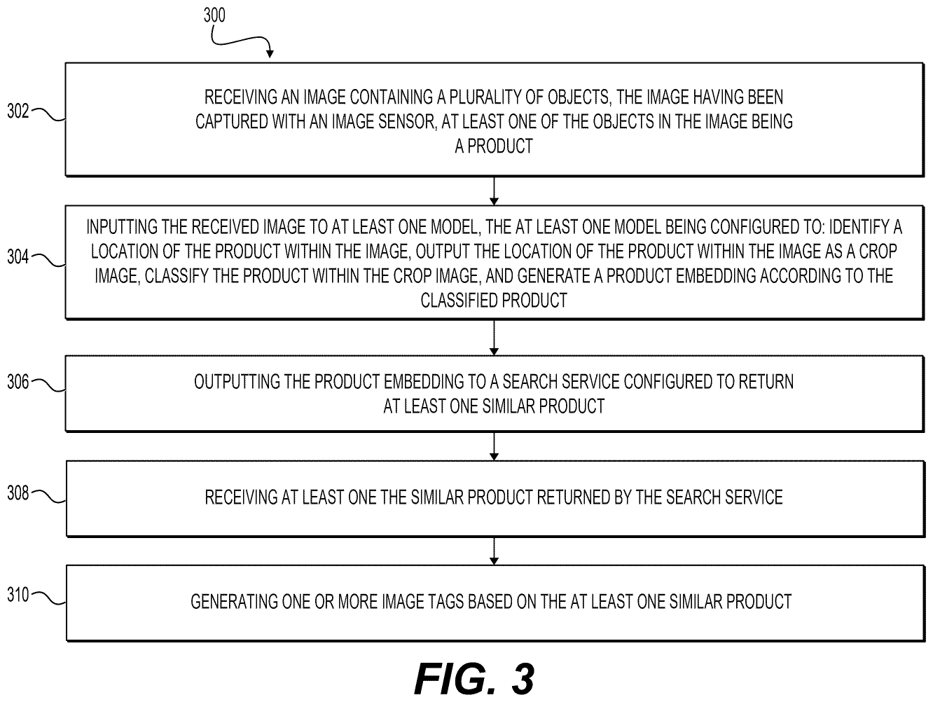

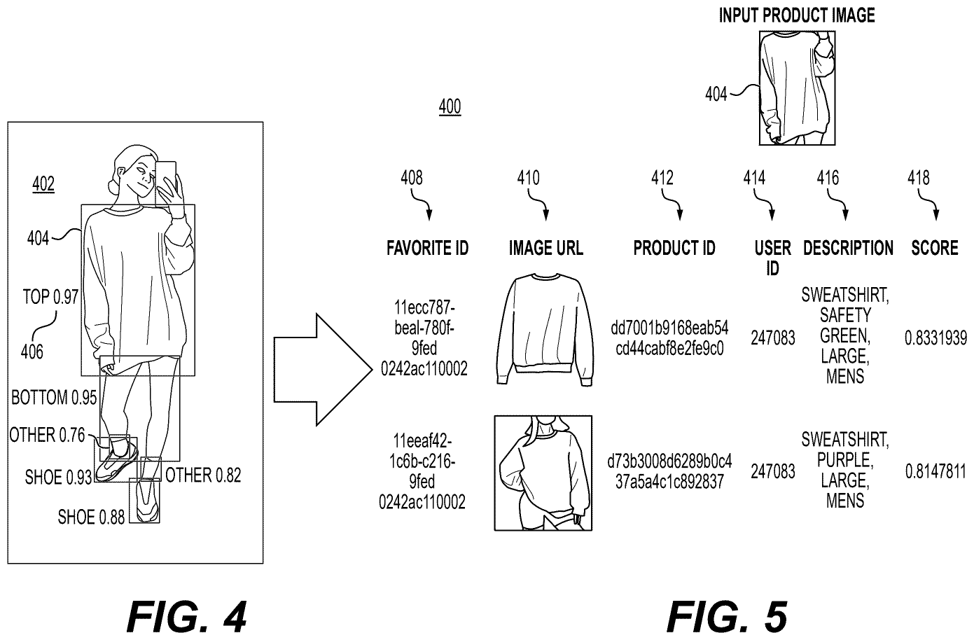

FIG. 3 is a flowchart of an example method 300 for image product identification and classification, and for generating a tag based on the identification and classification (e.g., for auto-tagging, including generation of a shoppable link). A step 302 may include receiving, with one or more processors, an image containing a plurality of objects, the image having been captured with an image sensor, at least one of the objects in the image being a product. FIG. 4 illustrates an example image 402, that may be received in step 302. The image may correspond to an image generated with image sensor 104 or another image selected or created via user device 102. With reference to the example system 200 in FIG. 2, the image may be associated with an event 202 or media selected in selection 236. In some examples, a video including a plurality of images (e.g., a plurality of image frames) may be received.

In a step 304, the received image may be input to at least one model, such as one or more of detection model 112, similarity model 116, similarity model 222, classification model 224, product detection model 240, or similarity model 242 (references below to models 112 and 116 are understood to refer to each of these models). The model may be configured to perform functions, including: identifying the location of the product within the image, output the location of the product within the image as a crop image, classify the product within the crop image, and generate a product embedding according to the classified product. In some examples, when a video including a plurality of images is received at step 302, a cover image identified or selected from among the images to represent the video may be provided as input to the at least one model. In other examples, the video may be processed by scene detector 111 to identify, from the plurality of images, one or more subsequent images from an initial image indicative of new or different objects included therein for input to the at least one model (e.g., in addition to the initial image), as described above in detail with reference to FIG. 1.

The function of identifying the location of the product within the image may be performed in a manner corresponding to FIG. 4. An image 402 may be analyzed with detection model 112 to identify portions of image 402 containing a product. In the example illustrated in FIG. 4, five potential products are identified, each enclosed within a rectangular portion of image 402 that forms a crop image, such as crop image 404. As used herein, a crop image is a portion of an image that is associated with a part or an entirety of a product.

In some examples, a crop image is an image portion extracted from image 402. Crop images may overlap each other and may include a portion of a product that is partially obscured. The crop image(s) generated in step 304 may be output, for example, to a second model such as similarity model 116 to perform the action of generating and outputting embeddings according to the product within each crop image generated from image 402.

As indicated above, step 304 may include classifying the product within the crop image. For example, each crop image may be evaluated with detection model 112 to determine one or more product classifications. Example classifications are presented as text in FIG. 4 (e.g., “top,” “bottom,” and “shoe”). Classification may be performed with detection model 112 as described above. FIG. 4 also illustrates confidence values 406 representing the likelihood that a product is correctly classified. In the example of FIG. 4, higher values represent higher levels of confidence, with a value of 1.00 representing a maximum possible confidence that the product is correctly classified with detection model 112.

Step 304 may further include generating a product embedding according to the classified product. Similarity model 116 may generate product embeddings for the crop image generated from image 402. In examples where multiple crop images are generated, multiple product embeddings may be generated, one for each identified product.

A step 306 may include outputting the product embedding to a search service configured to return product data associated with at least one similar product. In some examples, the search service is implemented via similarity model 116, as represented in FIG. 1, and/or visual search service 226 (FIG. 2). In other examples, the search service includes one or more search algorithms that are implemented separately from similarity model 116.

Step 308 may include receiving at least one similar product returned by the search service that was queried in step 306. For example, one or more similar products may be returned after querying search index 232 via visual search service 226 (FIG. 2). As indicated above, the search techniques may include a KNN query or other suitable technique. In some examples, the search in step 306 is performed on products that were favorited by a particular user and indexed in search index 232. These favorited products may be the only items searched (e.g., items that were not previously favorited are not searched), or items that are prioritized in the search, reducing computational load associated with the search. Product data for each similar product may also be identified in step 306 and received in step 308.

If desired, step 308 includes identifying similar products based on the determination that one or more similar embeddings exist for the embedding generated for the crop image. For example, a KNN technique may be utilized to identify embeddings similar to the embedding of the crop image (e.g., embeddings within a certain distance from the subject embedding). These similar embeddings may correspond to products that are similar to the product contained in the corresponding crop image. In some aspects, embeddings are only determined to be similar if they belong to the same classification even if the embeddings are otherwise determined to be similar.

A step 310 may include generating one or more image tags based on the at least one similar product. An image tag may include any data associated with the similar product. This information may be in the form of a product link (e.g., internet address link) that, when followed, directs a user viewing a content creator's post to a website or application associated with the product (e.g., to purchase the product). In particular, the information may be useful to generate a shoppable link, or the information may include a shoppable link. The image tag may be in the form of an image, a hashtag, an alphanumeric code (e.g., a discount code), narrative text, and others. In some examples, the image tag generated in step 310 may be created with tag generator 106 and/or via an external service in communication with user device 102 via an API or other suitable protocol.

FIG. 5 illustrates an example of similar products that were identified (e.g., on the basis of similar embeddings) in response to a search performed based on crop image 404, including product data 400 associated with the similar products. For example, a query based on crop image 404 may result in two potential similar products, each of which corresponds to a previously-favorited product. Product data 400 for these similar products may include a favorite identifier 408 (e.g., a unique alpha-numeric string that is unique for a particular user-product pair), an image locator 410 (e.g., an internet address associated with an image of the product), a product identifier 412 (e.g., an alphanumeric string that identifies a particular product and that may be shared with a plurality of different users), a user identifier 414 that identifies the user that favorited the products, a narrative description 416 (e.g., a description of the product, a description of the location of the product, product availability, etc.), and a product score 418 that represents the similarity of the product to the crop image 404.

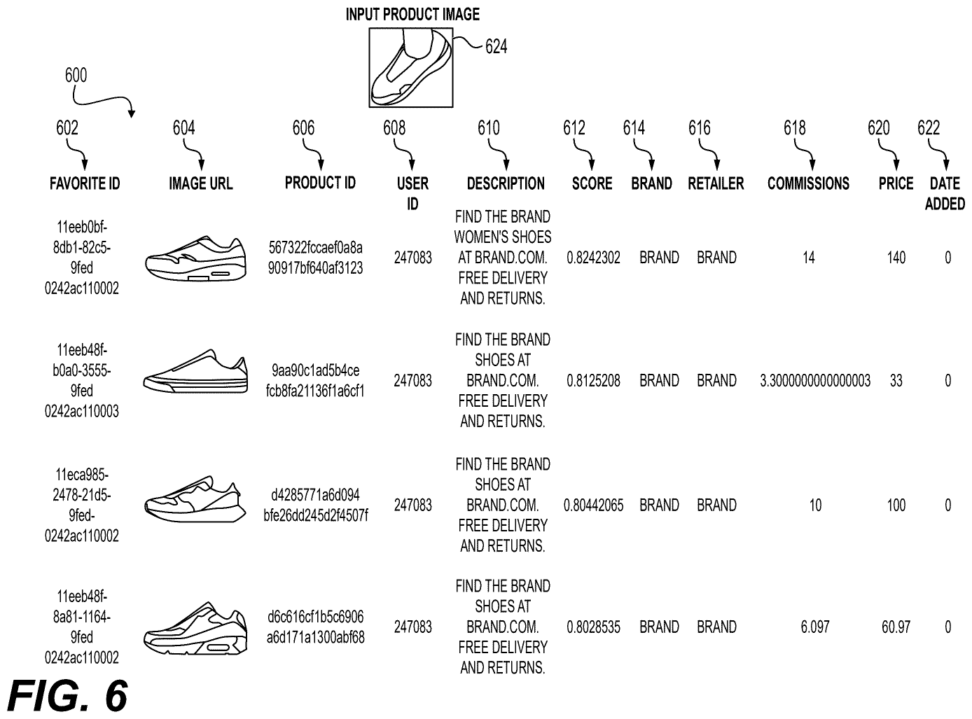

FIG. 6 includes additional product data 600, this product data 600 representing similar products that are identified in response to a search query for a product embedding generated for a crop image 624. Product data 600 may include a favorite identifier 602, an image locator 604, a product identifier 606, a user identifier 608, a narrative description 610, and a product score 612, as described above with respect to FIG. 5. FIG. 6 also illustrates product data 600 that includes a source identifier 614, a merchandiser identifier 616, a commission rate 618, a product value 620, and a recency identifier 622.

Source identifier 614 may identify a manufacturer, designer, brand, etc., of the product. Merchandiser identifier 616 may identify a retailer of the product, seller of the product, location of the product, distributor of the product, etc. Commission rate 618 may include a value (e.g., a rate), that a user (e.g., a content creator) may receive in response to a purchase of the product generated following creation of content (e.g., social media content). Product value 620 may indicate a monetary value (e.g., a price) of the product. Recency identifier 622 may indicate a date at which the product data 600 was generated or a date at which the product was favorited (e.g., a date the product and associated product data 600 was added to extracted products databases 128 or favorited products databases 130). In the example illustrated in FIG. 6, recency identifier 622 illustrates a number of days following the creation of product data 600 (each item in FIG. 6 being newly-added). In other examples, recency identifier 622 may be in the format of a date.

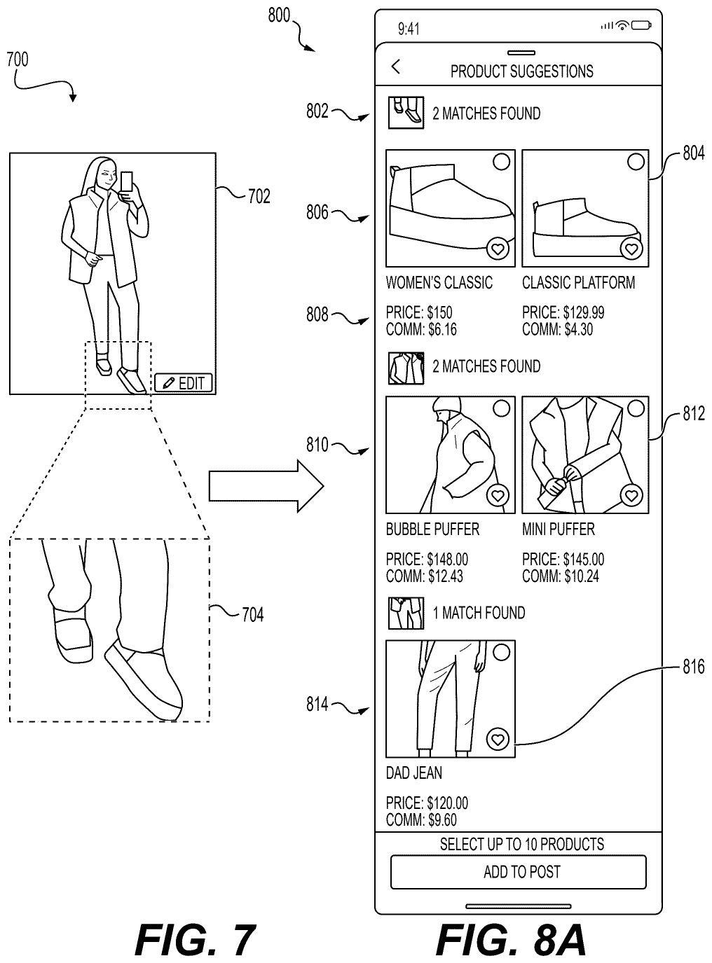

FIGS. 7-11B illustrate elements that may be displayed to a user during one or more stages of method 300. FIG. 7 illustrates a display 700 that may be presented on a display of user device 102 via tag generator 106. Display 700 may include an image 702 captured with image sensor 104. Image 702 may include one or more products and other objects. In some aspects, one or more additional objects (not shown) present in image 702 partially obscure a product of interest. A crop image 704 may be generated as discussed above. In some embodiments, the crop image 704 is not presented via the display of user device 102. In other embodiments, crop image 704 may be displayed (e.g., by displaying a box, classification, confidence value, etc.) via a display of user device 102.

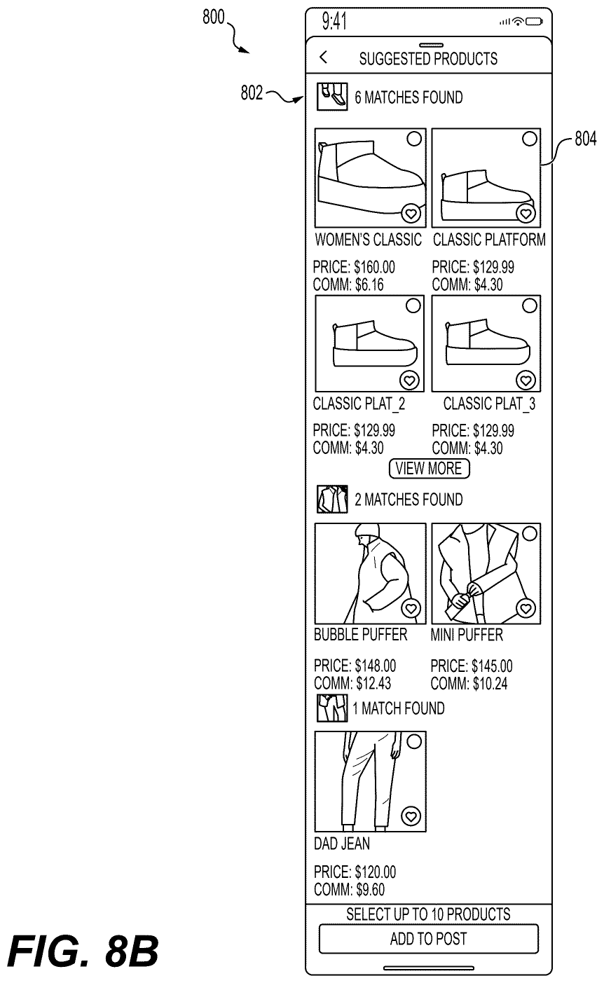

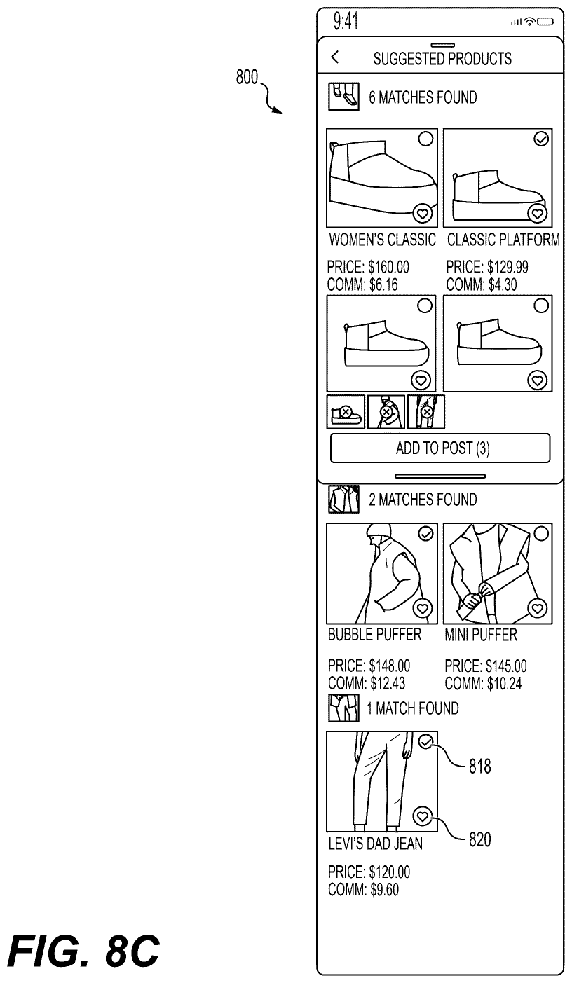

FIGS. 8A-8C illustrate an exemplary display 800 for dynamically presenting similar products via user device 102. With reference to FIG. 8A, exemplary display 800 may be generated based on the type and/or number of products identified in image 702. In some aspects, exemplary display 800 may include a first section 802 for displaying similar products belonging to a first classification, a second section 810 for displaying similar products belonging to a second classification, and a third section 814 for displaying similar products belonging to a third classification. Each section 810 may correspond to results generated for a different crop image.

Each section 802, 810, 814, may include similar product images 806 and one or more items of product data 808. In this example, the product name, product price, and an associated commission are illustrated in each section. Each section 802, 810, 814 may display a number of potential similar products. As described above, each similar product may correspond to product data stored in one or both of extracted product databases 128 and favorited products databases 130.

In some examples, sections 802, 810, and 814 may have a dynamically-generated size that corresponds to the number of similar products that were identified. In FIG. 8A, two similar products were found for the classification displayed in section 802, two similar products were found for the classification displayed in section 810, and one similar product was found for the classification displayed in section 814. Each section 802, 810, 814, may include product images 804, 812, 816, showing at least one of the similar products for the corresponding classification. A user may designate or otherwise select the appropriate product by interacting with the product image 804, 812, 816.

As shown in FIG. 8B, section 802 may display a number of similar products that is smaller than the number of similar products that were identified. In the illustrated example, display 800 presents four product images 804 of a total of six similar products that were identified. Additional entries for similar products may be displayed in response to receipt of an interaction with a graphical element (e.g., the “view more” graphical element illustrated in FIG. 8B) of display 800.

FIG. 8C illustrates graphical elements of display 800 for designating a similar product via a first graphical element 818 and favoriting a product via a second graphical element 820. In some aspects, a user interaction with graphical element 818 may result in an instruction for user device 102 to generate one or more image tags. A user interaction with graphical element 820 may cause user device 102 to perform one or more of the above-described functions for favoriting a product, including updating favorited products databases 130, and/or training data 120 for model re-training purposes.

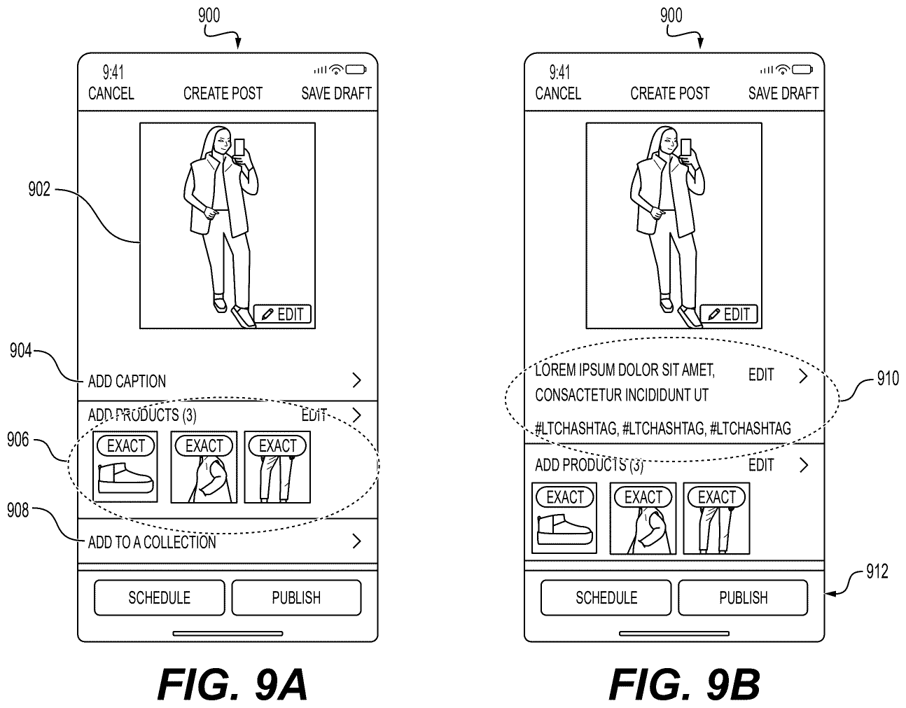

FIGS. 9A and 9B illustrate example displays 900 in which one or more products have been identified and tagged via system environment 100. As shown in FIG. 9A, an image 902 for publication is provided at an upper portion of display 900. A caption element 904 may enable a user to add descriptive text, hashtags, etc.

A tag section 906 may display each identified product for review by a viewer of displays 900. If desired, tag section 906 may identify a level of similarity between the products in image 902 and the identified product (e.g., a product selected by interacting with first graphical element 818 (FIG. 8C)). When the product is identical, an appropriate indication may include “EXACT,” “100%,” etc. When the identified product is not identical to the product in image 902, appropriate indications may include “SIMILAR,” “90%,” etc. Identified products, including tagged products, may be saved for future use and/or reference by interacting with a graphical element 908.

As shown in FIG. 9B, caption text 910 may be added following an interaction with element 904. Caption text 910 includes narrative text added manually by interacting with user device 102. In some aspects, some or all of caption text 910 may be generated automatically with tag generator 106. In particular, caption text 910 may include one or more hashtags, internet addresses, application or website links, product information, other product data, etc. This generated text may be user-viewable, user-editable, etc. A user may interact with publication elements 912 (e.g., “SCHEDULE,” “PUBLISH”) that finalize a publication with the images.

In some aspects, the information in caption text 910, and/or information that is otherwise embedded in a publication generated based on an interaction with element 912, includes a shoppable link. This shoppable link may be included in product data (e.g., stored in database(s) 128, 130). The shoppable link may be generated based on a similar product, such as a product designated by an interaction with graphical element 818.

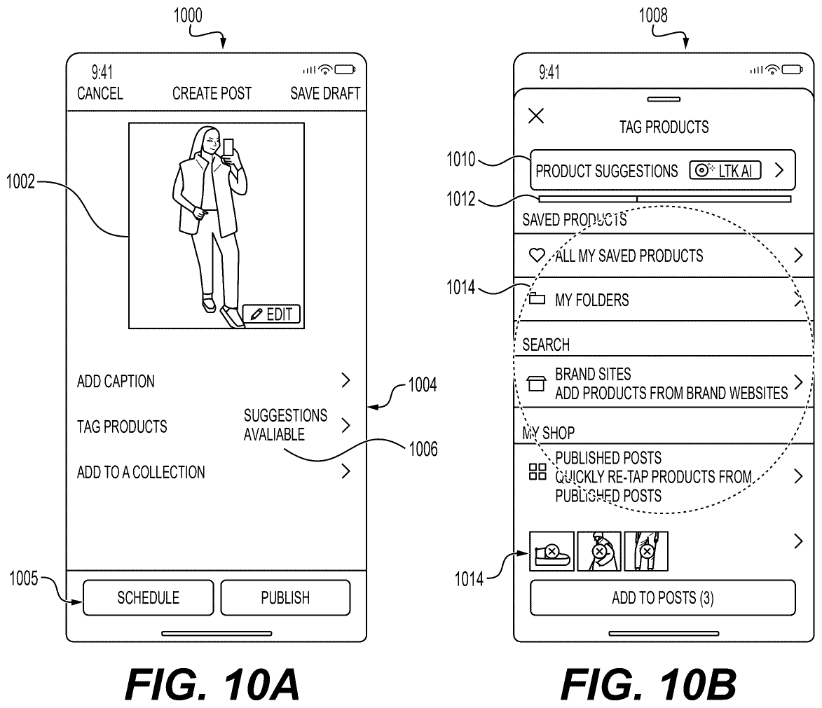

FIGS. 10A and 10B illustrate example displays 1000 and 1008, respectively, which may be presented when image identification, auto-tagging, and/or link-generation functions are performed with detection model 112 and similarity model 116. FIG. 10A shows an image 1002 and publication elements 1005, which may function similar to publication elements 912 (FIG. 9B). One or more portions of illustrated example displays 1000 may include a tag element 1004 for tagging one or more products. An interaction with tag element 1004 may cause the display to transition to display 800 (FIGS. 8A-8C), for example.

An element 1006 may indicate when an auto-tagging process is available, is in process, or has concluded. For example, element 1006 may be presented when user device 102 identifies one or more similar products by determining similar embeddings with similarity model 116, alerting the user to the ability to include data generated for auto-tagging in a content publication, such as generation of a shoppable link.

A display 1008 may include a graphical element 1010 that identifies that detection model 112 and similarity model 116 are performing processes for identifying similar products. If desired a progress estimate element 1012 may provide a graphical or numerical indication relating to an elapsed amount of time during which similar embeddings are sought, a remaining amount of time until a search for similar embeddings is expected to conclude, etc. If desired, additional graphical elements 1014 allow a user to perform actions and otherwise interact with a content creation and/or publishing application without pausing or interrupting the auto-tagging process. Elements 1014 may indicate the presence of existing tags.

The systems and processes herein may facilitate the publication of information (e.g., via one or more content creators), automating a process of identifying a product with in an image and generating a content based on the identified product and associated product data. With reference to FIG. 10A, in response to the interaction with publication element 1005, the system may cause publication of image 1002. The publication may include some or all of the product data for the identified product(s), metadata associated with the identified product(s), and other information that is not manually input by the content creator.

FIGS. 11A and 11B illustrate example displays 1100 and 1108, respectively, which may be presented when image identification, auto-tagging, and/or link-generation functions are performed with detection model 112 and similarity model 116 with respect to a video. FIG. 11A shows an image 1102 corresponding to a selected image 1105 among a series of images comprising a video that are displayed within an interactive visual representation 1104 (e.g., a timeline) of the video. Visual representation 1104 may be interacted with to select another image from the series of images. In response to the selection of the other image, the image 1102 may be replaced with the other selected image in display 1100.

FIG. 11A also shows video editing elements 1106 (e.g., “TRIM” and “COVER” elements) that can be used in conjunction with visual representation 1104 to edit the video. For example, visual representation 1104 may include one or more graphical trimming elements that may be movable within visual representation 1104 to select or otherwise identify a portion of the video to be published. In some examples, the graphical trimming elements are displayed and enabled to be interacted with upon a first selection of the “TRIM” element. In such examples, a second selection of the “TRIM” element may then cause the selection or identification of the portion of the video based on the positioning of the graphical trimming elements within visual representation 1104 at a time of the second selection. In other examples, the graphical trimming elements may always be displayed and enabled to be interacted with via visual representation 1104 on display 1100, and a selection of the “TRIM” element causes the selection or identification of the portion of the video based on the positioning of the graphical trimming elements within visual representation 1104 at a time of the selection. In some embodiments, if only a portion of the video is selected to be published using the “TRIM” element, then only that portion of the video may be analyzed in association with the image identification, auto-tagging, and/or link-generation functions. For example, only a subset of the images included in the portion of the video may be processed by scene detector 111 to identify one or more images from the subset for input to detection model 112.

Additionally, video editing elements 1106 may include the “COVER” element that may be interacted with to cause a selection of an image from among the series of images comprising the video as the cover image representative of the video. For example, a selection of the “COVER” element, when image 1102 corresponding to selected image 1105 in visual representation 1104 is displayed, may cause image 1102 to be selected as the cover image representative of the video.

Display 1108 of FIG. 11B shows a cover image 1110 for the video (e.g., image 1102 selected from FIG. 11A) and publication elements 1112, which may function similarly to publication elements 912 (FIG. 9B) or publication elements 1005 (FIG. 10A). One or more portions of illustrated example display 1108 may include a tag element 1114 for tagging one or more products. An interaction with tag element 1114 may cause the display to transition to a display similar to that of display 800 (FIGS. 8A-8C), for example, but including similar products to the products identified within at least cover image 1110 or within any (and/or all) images of comprising the video.

For example, as discussed above in detail with reference to FIG. 1, in some embodiments, only the cover image 1110 representing the video (e.g., image 1102 selected from FIG. 11A) may be processed by detection model 112 and similarity model 116 to enable tagging of similar products to the products identified within the cover image (e.g., similar to if an image, as opposed to a video, had been received). In other embodiments, multiple images (e.g., multiple image frames from the series of image frames comprising the video) may be processed by detection model 112 and similarity model 116 to enable tagging of similar products to the products identified throughout an entirety of the video, including those that may otherwise not be included in the cover image. Specifically, the images processed may be those determined by scene detector 111 as having a change in scene (e.g., a change in content) from a previous image that exceeds a threshold difference indicative of a new or different object or product in the image. In such examples, the display provided in response to interaction with tag element 1114 may include all products identified, including those not present in the cover image 1110. Additionally, the products may be displayed in association with a time stamp identifying a time period in the video when the products appear.

An element 1116 may indicate when an auto-tagging process is available, is in process, or has concluded. For example, element 1116 may be presented when the similar products have been identified, alerting the user to the ability to include data generated for auto-tagging in a content publication, such as generation of a shoppable link. In some examples, a display similar to that of display 1008 of FIG. 10B may be provided as detection model 112 and similarity model 116 are performing processes for identifying the similar products.

The systems and processes herein may facilitate the publication of information (e.g., via one or more content creators), automating a process of identifying a product within a video and generating a content based on the identified product and associated product data. With reference to FIG. 11B, in response to the interaction with publication element 1112, the system may cause publication of the video with cover image 1110 as the representative image thereof. The publication may include some or all of the product data for the identified product(s), metadata associated with the identified product(s), and other information that is not manually input by the content creator.

FIG. 12 illustrates an implementation of a computer system that executes techniques presented herein. The computer system 1200 includes a set of instructions that are executed to cause the computer system 1200 to perform any one or more of the methods or computer based functions disclosed herein. The computer system 1200 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 1200 operates in the capacity of a server or as a client user computer in a server-client user network environment, or as a peer computer system in a peer-to-peer (or distributed) network environment. The computer system 1200 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 1200 is implemented using electronic devices that provide voice, video, or data communication. Further, while the computer system 1200 is illustrated as a single system, the term “system” shall also be taken to include any collection of systems or sub-systems that individually or jointly execute a set, or multiple sets, of instructions to perform one or more computer functions.

As illustrated in FIG. 12, the computer system 1200 includes a processor 1202, e.g., a central processing unit (CPU), a graphics processing unit (GPU), or both. The processor 1202 is a component in a variety of systems. For example, the processor 1202 is part of a standard personal computer or a workstation. The processor 1202 is one or more processors, digital signal processors, application specific integrated circuits, field programmable gate arrays, servers, networks, digital circuits, analog circuits, combinations thereof, or other now known or later developed devices for analyzing and processing data. The processor 1202 implements a software program, such as code generated manually (i.e., programmed).

The computer system 1200 includes a memory 1204 that communicates via bus 1208. Memory 1204 is a main memory, a static memory, or a dynamic memory. Memory 1204 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1204 includes a cache or random-access memory for the processor 1202. In alternative implementations, the memory 1204 is separate from the processor 1202, such as a cache memory of a processor, the system memory, or other memory. Memory 1204 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1204 is operable to store instructions executable by the processor 1202. The functions, acts, or tasks illustrated in the figures or described herein are performed by processor 1202 executing the instructions stored in memory 1204. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 1200 further includes a display 1210, such as a liquid crystal display (LCD), an organic light emitting diode (OLED), a flat panel display, a solid-state display, a cathode ray tube (CRT), a projector, a printer or other now known or later developed display device for outputting determined information. The display 1210 acts as an interface for the user to see the functioning of the processor 1202, or specifically as an interface with the software stored in the memory 1204 or in the drive unit 1206.

Additionally or alternatively, the computer system 1200 includes an input/output device 1212 configured to allow a user to interact with any of the components of the computer system 1200. The input/output device 1212 is a number pad, a keyboard, a cursor control device, such as a mouse, a joystick, touch screen display, remote control, or any other device operative to interact with the computer system 1200.

The computer system 1200 also includes the drive unit 1206 implemented as a disk or optical drive. The drive unit 1206 includes a computer-readable medium 1222 in which one or more sets of instructions 1224, e.g. software, is embedded. Further, the sets of instructions 1224 embodies one or more of the methods or logic as described herein. Instructions 1224 resides completely or partially within memory 1204 and/or within processor 1202 during execution by the computer system 1200. The memory 1204 and the processor 1202 also include computer-readable media as discussed above.

In some systems, computer-readable medium 1222 includes the set of instructions 1224 or receives and executes the set of instructions 1224 responsive to a propagated signal so that a device connected to network 1230 communicates voice, video, audio, images, or any other data over network 1230. Further, the sets of instructions 1224 are transmitted or received over the network 1230 via the communication port or interface 1220, and/or using the bus 1208. The communication port or interface 1220 is a part of the processor 1202 or is a separate component. The communication port or interface 1220 is created in software or is a physical connection in hardware. The communication port or interface 1220 is configured to connect with the network 1230, external media, display 1210, or any other components in the computer system 1200, or combinations thereof. The connection with network 1230 is a physical connection, such as a wired Ethernet connection, or is established wirelessly as discussed below. Likewise, the additional connections with other components of the computer system 1200 are physical connections or are established wirelessly. Network 1230 alternatively be directly connected to the bus 1208.

While the computer-readable medium 1222 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 1222 is non-transitory, and may be tangible.

The computer-readable medium 1222 includes a solid-state memory such as a memory card or other package that houses one or more non-volatile read-only memories. The computer-readable medium 1222 is a random-access memory or other volatile re-writable memory. Additionally or alternatively, the computer-readable medium 1222 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 1200 is connected to network 1230. Network 1230 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. Network 1230 includes wide area networks (WAN), such as the Internet, local area networks (LAN), campus area networks, metropolitan area networks, a direct connection such as through a Universal Serial Bus (USB) port, or any other networks that allows for data communication. Network 1230 is configured to couple one computing device to another computing device to enable communication of data between the devices. Network 1230 is generally enabled to employ any form of machine-readable media for communicating information from one device to another. Network 1230 includes communication methods by which information travels between computing devices. Network 1230 is divided into sub-networks. The sub-networks allow access to all of the other components connected thereto or the sub-networks restrict access between the components. Network 1230 is regarded as a public or private network connection and includes, for example, a virtual private network or an encryption or other security mechanism employed over the public Internet, or the like.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for product identification and classification in an image, the method comprising:
receiving, with one or more processors, an image containing a plurality of objects, the image having been captured with an image sensor, at least one of the plurality of objects in the image being a product;
inputting, with the one or more processors, the received image to at least one model, the at least one model being configured to:
identify a location of the product within the image,
output the location of the product within the image as a crop image,
generate a product classification for the product in the crop image, and
generate a product embedding according to the product classification,
outputting, with the one or more processors, the product embedding to a search service configured to return product data associated with at least one similar product;
receiving, with the one or more processors, the product data returned by the search service; and
generating, with the one or more processors, one or more image tags based on the at least one similar product.

2. The computer-implemented method of claim 1, wherein the at least one model includes an object detection model or an object similarity model.

3. The computer-implemented method of claim 1, wherein the at least one model is further configured to generate model re-training data based on the product embedding.

4. The computer-implemented method of claim 1, wherein the at least one model includes a first model and a second model, the first model being configured to generate the product classification, and the second model being configured to generate the product embedding based on the product classification.

5. The computer-implemented method of claim 1, further including causing display of:
a plurality of images corresponding to a plurality of products including the at least one similar product; and
at least some of the product data, including a product identifier, product value, or product source.

6. The computer-implemented method of claim 1, wherein the at least one model is further configured to generate model training data based on the product embedding.

7. The computer-implemented method of claim 1, further including causing re-training of the at least one model in response to receipt of one or more product favoriting inputs.

8. A system for product identification and classification in an image, the system comprising:
a data storage device storing instructions; and
a processor configured to execute the instructions to perform a method including:
receiving an image containing a plurality of objects, the image having been captured with an image sensor, at least one of the plurality of objects in the image being a product;
inputting the received image to at least one model, the at least one model being configured to:
identify a location of the product within the image,
output the location of the product within the image as a crop image,
generate a product classification for the product in the crop image, and
generate a product embedding according to the product classification,
outputting the product embedding to a search service configured to return product data associated with at least one similar product;
receiving the product data returned by the search service; and
generating one or more image tags based on the at least one similar product.

9. The system of claim 8, wherein the at least one model includes an object detection model or an object similarity model.

10. The system of claim 8, wherein the at least one model is further configured to generate model re-training data based on the product embedding.

11. The system of claim 8, wherein the at least one model includes a first model and a second model, the first model being configured to generate the product classification, and the second model being configured to generate the product embedding based on the product classification.

12. The system of claim 8, the method further including causing display of:
a plurality of images corresponding to a plurality of products including the at least one similar product; and
at least some of the product data, including a product identifier, product value, or product source.

13. The system of claim 8, wherein the at least one model is further configured to generate model training data based on the product embedding.

14. The system of claim 8, the method further including causing re-training of the at least one model in response to receipt of one or more product favoriting inputs.

15. A non-transitory machine-readable medium storing instructions that, when executed by a computing system, causes the computing system to perform a method including:
receiving an image containing a plurality of objects, the image having been captured with an image sensor, at least one of the plurality of objects in the image being a product;
inputting the received image to at least one model, the at least one model being configured to:
identify a location of the product within the image,
output the location of the product within the image as a crop image,
generate a product classification for the product in the crop image, and
generate a product embedding according to the product classification,
outputting the product embedding to a search service configured to return product data associated with at least one similar product;
receiving the product data returned by the search service; and
generating one or more image tags based on the at least one similar product.

16. The non-transitory machine-readable medium of claim 15, wherein the at least one model includes an object detection model or an object similarity model.

17. The non-transitory machine-readable medium of claim 15, wherein the at least one model is further configured to generate model re-training data based on the product embedding.

18. The non-transitory machine-readable medium of claim 15, wherein the at least one model includes a first model and a second model, the first model being configured to generate the product classification, and the second model being configured to generate the product embedding based on the product classification.

19. The non-transitory machine-readable medium of claim 15, the method further including causing display of:
a plurality of images corresponding to a plurality of products including the at least one similar product; and
at least some of the product data, including a product identifier, product value, or product source.

20. The non-transitory machine-readable medium of claim 15, wherein the at least one model is further configured to generate model re-training data based on the product embedding.
